(19) United States
(12) Patent Application Publication
(10) Pub. No.: US 2016/0095324 A1
(43) Pub. Date: Apr. 7, 2016

(54) Creative and Unique Holding Systems For Top of Cakes

(71) Applicant: Leslie Elizabeth Jones, Norwalk, CA (US)

(72) Inventor: Leslie Elizabeth Jones, Norwalk, CA (US)

(21) Appl. No.: 14/507,803

(22) Filed: Oct. 6, 2014

(51) Int. Cl. A21C 15/00

(52) U.S. Cl. CPC A21C 15/00

(57) ABSTRACT

This subject matter provides the user with a variety of arrangements of decorative features on top of cakes in any celebration (birthdays, weddings, anniversaries, etc.). There are a variety of designs but all are within the same function family. A number of the designs allow the customer to be creative and arrange the holding systems to their liking, such as, letters, numbers, or borders. The others give an illusion of levitation on top or around cakes.

### CROSS-REFERENCE TO RELATED APPLICATIONS

The following is a tabulation of some prior art that presently appears relevant:

### U.S. Patents

| Pat. No. | Kind Code | Issue Date | Patentee |
|---|---|---|---|
| 2,786,345 | A | Mar. 26, 1957 | Lucille E. Scherer |
| 2,468,505 | A | Apr. 26, 1949 | Albert G. McNeill |
| 1,879,477 | A | Sep. 27, 1932 | Marian F. Powell |
| 1,511,004 | A | Oct. 7, 1924 | Walter H. Pooch |
| | | | Martin M. Koeppen |

### Foreign Patent Documents

| Foreign | | | | |
|---|---|---|---|---|
| Doc. Nr. | Cntry Code | Kind Code | Pub. Dt | App or Patentee |
| 0874192 | EP | A2 | Oct. 28, 1988 | John J. Lane |
| 0695910 | EP | A1 | Feb. 7, 1996 | John Lane |

### BACKGROUND

Cakes have been around since the 1800's and there are not many systems that demonstrate decorative features for top of cakes. This inventive idea gives the customer options on ways to celebrate with people they love, trust and want to impress. The holding systems displayed look very cool, unique, creative, and will add value to the customers' celebration. These holding systems will be a great novelty or memorandum for customers.

This imaginative idea initially came to realization as I was sitting on the couch dozing off watching television. As I dozed off, but moments before I came back into full consciousness, I had a vision of cakes. On the top of the cake was a perfectly circular arrangement of decorative features. I said to myself, “Those candles must be on top of something to make them perfectly circular.” I have seen people who have tried to create different arrangements by hand with decorative features on top of cakes which resulted unpleasing to the eye. After that idea, I continued to contemplate and determine that there can be multiple holding systems for decorative features on top of cakes.

As time passed, I decided to further my education in drafting and design. The process of turning mire thought into reality was not an easy task. To defer the cost of hiring someone to draft and design these holding systems, I began to sketch and draft my own inventive ideas on paper. In lieu of utilizing an intermediary, I searched the internet for a computer program called “Inventor” which is one of many programs under the Autodesk umbrella. Operating this software, drafting became second nature which brings me to this point.

### Prior Art

There are several types of holding systems for cakes that have been proposed in preceding years:
(1) U.K. patent EP0874192 to EP0695910 (1998) both invented by John Lane; U.S. Pat. No. 2,786,345 (1957) by L. Scherer; (2) U.S. Pat. No. 2,468,505 (1949) by A. McNeill; (3) U.S. Pat. No. 1,879,477 (1932) by M. Powell; (4) U.S. Pat. No. 1,511,004 (1924) by W. Pooch and M. Koeppen. U.K. patent EP0874192 invented by John Lane is limited to numerical decorative features. This feature does not allow the purchaser to place the decorative feature to their liking. It also narrowed the candle placement to one area on the cake and restricting the space where there could be room for decorative writings or pictures of the celebrant. FIG. 6 of the U.K. patent EP0874192 is limited to a rectangle shape and cannot be transfigured to display a different arrangement to display candles.

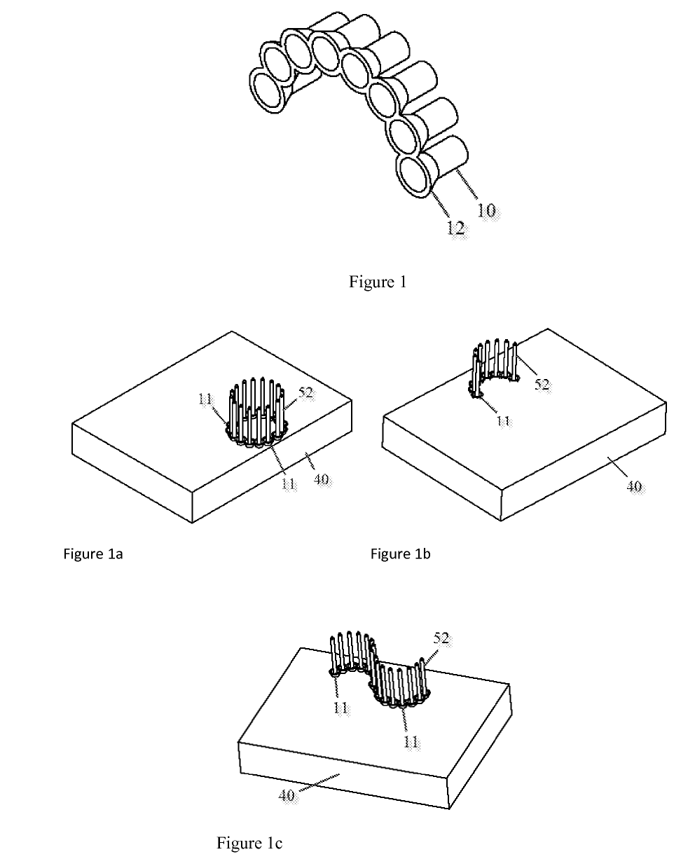

When it comes to a birthday celebration it is all about the celebrant, the cake which guests will partake with the celebrant, and the candles symbolizing the years of life. U.K. patent EP0695910 FIGS. 1, 4, and 11 are distractions from the cake and candles due to the fact that it takes up too much space on the cake. If certain amount of candles are not needed the display is still using unnecessary area of the cake. Certain elements are needed for this type of holding systems: (1) electricity and (2) a battery. These elements eliminate the sentimental value of candles that signifies the life of the celebrant. Without the electricity and the battery, there is no illumination. If a customer just wants a traditional candle illumination, they would incur costs for the battery illumination even though they are not using it. In FIGS. 6, 9, and 11, these holding systems limits how the purchasers place the holding features and restricts the creativity of the decorator. The disadvantage of FIG. 5 is that there is no capture feature that prevents the wax from falling on the cake. The pegs are designed to hold the candles in a parallel manner but there are no capture features for melting wax.

U.S. Pat. No. 2,786,345, can only hold one (1) to three (3) candles at a time and the holding feature is limited in placement. The holding components can only be placed on the edges of the cakes and there is no capture feature for the melting wax. The melting wax will fall on the cake or stand on which the cake is placed upon.

U.S. Pat. No. 1,879,477, holding feature has a penetrating component that is too long which implies unnecessary material used to hold features in place. In addition, the holding feature takes up the majority of the top surface area of the cake preventing any decorative icing features on top of the cake, such as, the celebrants name or pictures. The holding feature is also limited in variation of placement. Even though the holding objects pedal-like components can be moved, it limits the creativity of the decorator to working with just the object and preventing other décorideas relating to the cakes surface.

U.S. Pat. No. 1,511,004, is also limited on placement. It provides only a circular position of candles, limiting the creativity of the decorator. If the preferred material is metal, as stated in the patent specifications, it will take away the decorative icing features and diminish aesthetics. There could be less material used to have the same affect.

### ADVANTAGES

There are several advantages of one or more aspects of my inventive idea. (1) The holding systems give the purchaser variety in placement choice on top or around cakes, (2) more attractive, (3) some of the holding systems give a sense of levitation to the features placed inside the provided openings, (4) easier to manufacture in turn relatively inexpensive, (5) can be recyclable aiding waste management depending on material selected. These and other advantages of one or more aspects will become apparent from a consideration of the ensuing description and accompanying drawings.

### DRAWINGS

### Figures

The figures provided herein are not necessarily drawn to scale and some components and features are exaggerated for clarity:

FIG. 1 is an arc-like shaped holding system in auxiliary view. FIGS. 1a, 1b, and 1c are examples of placement options the purchaser has relating to FIG. 1 and a cake but not limited to what is shown.

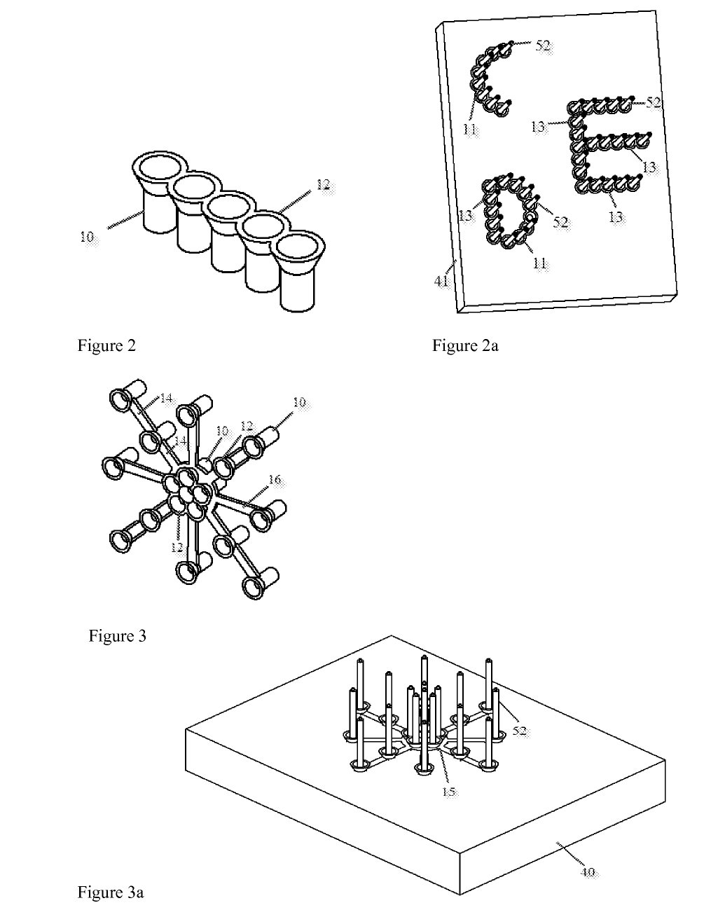

FIG. 2 is like a straight line holding system in auxiliary view. FIG. 2a is an example of FIGS. 1 and 2 placement options for the purchaser in relation to the cake but not limited to what is shown.

FIG. 3 is a shooting star-like shaped holding system shown in auxiliary view. FIG. 3a is an example of FIG. 3 placement options for the purchaser in relation to the cake but not limited to what is shown.

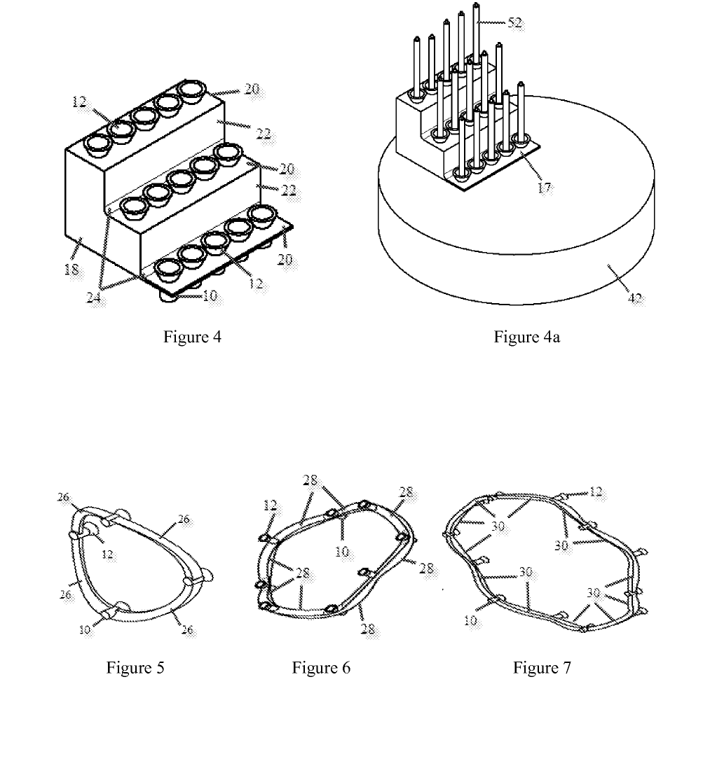

FIG. 4 is a choir stand-like holding system in auxiliary view. FIG. 4a is an example of FIG. 4 placement options for the purchaser in relation to the cake but not limited to what is shown.

FIG. 5 is a circular roller coaster-like shape holding system in auxiliary view.

FIG. 6 is a circular roller coaster-like shape holding system in auxiliary view with a larger diameter that FIG. 5.

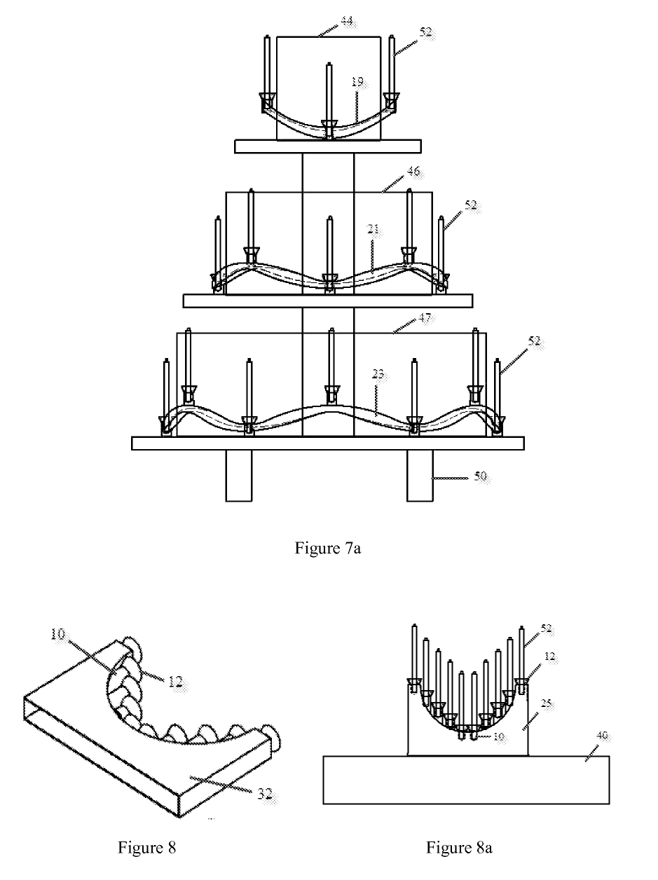

FIG. 7 is a circular roller coaster-like shape holding system in auxiliary view with a larger diameter that FIG. 6. FIG. 7a is an example of FIG. 5, FIG. 6, and FIG. 7 placement options for the purchaser in relation to the cake but not limited to what is shown.

FIG. 8 is a ramp-like holding system in auxiliary view. FIG. 8a is an example of FIG. 8 placement options for the purchaser in relation to the cake but not limited to what is shown.

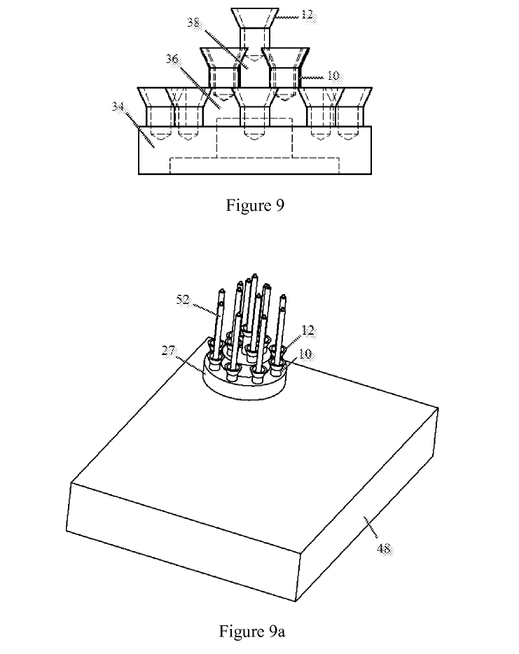

FIG. 9 is a circular tri-level holding system in auxiliary view. FIG. 9a is an example of FIG. 9 placement options for the purchaser in relation to the cake but not limited to what is shown.

DRAWINGS -Reference Numbers

| | |
|---|---|
| 10 | embeds |
| 11 | FIG. 1 |
| 12 | capture feature |
| 13 | FIG. 2 |
| 14 | connector |
| 15 | FIG. 3 |
| 16 | long connector |
| 17 | FIG. 4 |
| 18 | stability arm |
| 19 | FIG. 5 |
| 20 | base |
| 21 | FIG. 6 |
| 22 | perpendicular base |
| 23 | FIG. 7 |
| 24 | fillet |
| 25 | FIG. 8 |
| 26 | bridge 1 |
| 27 | FIG. 9 |
| 28 | bridge 2 |
| 30 | bridge 3 |
| 32 | ramp |
| 34 | level 1 |
| 36 | level 2 |
| 38 | level 3 |
| 40 | Cake A |
| 41 | Cake B |
| 42 | Cake C |
| 44 | Cake D |
| 46 | Cake E |
| 48 | Cake F |
| 50 | 3 tier cake stand |
| 52 | candles |

### DETAILED DESCRIPTION

### First Embodiment

One embodiment of the holding system component is illustrated in FIGS. 1, 1a, 1b, and 1c. FIG. 1 foundation is comprised of eight holding system components but not limited to eight in auxiliary view. The holding system component is a circular embed 10 with a roughly measured height of 0.5 inches and a diameter of 0.37 inches positioned in an arc-like array. Extruding from the top of embed 10 is capture feature 12 in a funnel-like shape typically measuring 0.25 inches in height and 0.6 inches in diameter. The capture features 12 are connected at the brim to the right and the left to create one holding system 11. In the center of each holding system component is a hole roughly measured: diameter 0.25, distance 0.60, and countersink diameter 0.45 at 44 degrees. In one embodiment, the holding system component is plastic, such as PET or PETE (polyethylene terephthalate), which adds a recycling aspect aiding the environment by helping with waste management. However, the holding system component can consist of any other material.

### Operation

### FIG. 1-1c

The holding system 11 is fairly simple in operation and functionality. Embeds 10 of the holding system 11 is inserted into the cake, leaving the capture features 12 above the cakes surface. It is the purchaser's choice to place in any manner and amount of the holding system 11 with the options of implanting any fixture inside the capture feature 12. The implanting fixture is preferably birthday candles 52. Once implanted, the preferred birthday candles 52 are lit causing a precise arc-like display and showcasing excellent décor on top of cake 40. With the capture features 12 attached to embeds 10, it prevents melted wax spillage on top of cake 40. Once the candles 52 are ready to be removed, grab the holding system 11 with two fingers or more and apply an upward movement. The candles 52 and holding system 11 are detached from the cake 40 at the same time, saving removal time and a swifter wax-free slicing/consumption of the cake 40. Thus, since the preferred material is polyethylene terephthalate (not limited to PETE), which is resistant to melting temperatures of candle wax, safe to contact with foodstuffs, the purchaser can reuse product for future celebrations, and/or recycle product participating in environmental-friendliness. FIGS. 1a, 1b, and 1c gives several display options relating to the cake 40 for the purchaser but not limited to these displays.

### Second Embodiment

FIGS. 2 and 2a illustrates another embodiment of the holding system component. FIG. 2 foundation of the holding system 13 comprises of five holding system components, but not limited to five. The five holding system components are placed next to each other in linear form and connect at the brim of the capture features 12 to make one holding system 13. The holding system components are circular embeds 10 with a roughly measured height of 0.5 inches and a diameter of 0.37 inches positioned linearly. Extruding from the top of embeds 10 are capturing features 12 in a funnel-like shape typically measuring 0.25 inches in height and 0.6 inches in diameter. In the center of each holding system component is a hole roughly measured: diameter 0.25, distance 0.60, and countersink diameter 0.145 at 44 degrees. In the second embodiment, the holding system component can plastic, such as PET or PETE (polyethylene terephthalate), which adds a recycling element aiding the environment by helping with waste management. However, the holding system component can consist of any other material.

### Operations

### FIGS. 2 and 2a

The holding system 13 is fairly simple in operation and functionality. Embeds 10 of the holding system 13 are inserted into the cake 40, leaving the capture features 12 above the cakes surface. It is the purchaser's choice to place in any manner and amount of the holding system 13 with the options of implanting any fixture inside the capture feature 12. The implanting fixture is preferably birthday candles 52. Once implanted, the preferred birthday candles 52 are lit causing a precise linear formation of candle décor on top of cake 40. With the capture features 12 attached to embeds 10, it prevents melted wax spillage on top of the cake 40. Once the candles 52 are ready to be removed, grab the holding system with two fingers or more and move the holding system 13 upwardly. The candles 52 and holding system 13 are detached from the cake 40 at the same time, saving removal time and a swifter wax-free slicing/consumption of the cake 40. Thus, since the preferred material (not limited to) is polyethylene terephthalate (PETE), which is resistant to melting temperatures of candle wax, safe to contact with foods, the purchaser can reuse product for future celebrations, and/or recycle product participating in environmental-friendliness. FIG. 2a also gives a perspective of adding different holding systems together to display letters or any design to the liking on top of cake 40.

### Third Embodiment

FIGS. 3 and 3a illustrates another embodiment of the holding system component. FIG. 3 foundation of the holding system 15 comprises of eighteen embeds 10, but not limited to eighteen. The eighteen embeds 10 are placed in a shooting star-like formation joined by different length connectors 14/16 of material placed on top of embeds 10 intersecting where the capture features 12 and embeds 10 meet. Extruding from where embeds 10 and connectors 14/16 meet are the capture features 12. The holding system components are circular embeds 10 with a roughly measured height of 0.5 inches and a diameter of 0.37 inches positioned in a shooting star-like formation. Extruding from the top of embeds 10 are capturing features 12 in a funnel-like shape typically measuring 0.25 inches in height and 0.6 inches in diameter.

In the center of the shooting star-like holding system 15 are five holding system components. One holding system component in the center with four surrounding holding system components attached at the brim. Extruding horizontally from the center of the grouped holding system components are eight connectors 14/16. Four of the eight connectors 14 extrude north, south, east, and west from the centered grouped holding system components with an estimated length of 2.81, width of 0.25, and thickness of 0.1 inches. Another holding system component is placed at 1.56 inches and a second holding system component is placed at 2.81 inches along each connector, roughly. Resulting in eight additional holding system components placed, two on each connector 14. Secondly, the last four long connectors 16 extrude northeast, southeast, southwest, and northwest have a length of 2.21, width of 0.25, and thickness of 0.1 inches with one holding system component placed at the end of each long connector 16 in estimation. Resulting in four additional holding system components placed. In conclusion, but not limited to, eighteen holding system components connected forming one holding system. In the third embodiment, the holding system component is plastic, such as PET or PETE (polyethylene terephthalate), which adds a recycling trait aiding the environment by helping with waste management. However, the holding system component can consist of any other material.

### Operation

### FIGS. 3 and 3a

The holding system 15 is fairly simple in operation and functionality. Embeds 10 of the holding system 15 are inserted into the cake 40, leaving the capture features 12 and connectors 14/16 above the cake 40 surface. Placed in a manner and amount of the purchasers choice with the options of implanting any fixture inside the capture features 12. The implanting fixture is preferably birthday candles 52. Once implanted, the preferred birthday candles 52 are lit causing a precise shooting star-like illusion of candle décor on top of cake 40. With the capture features 12 attached to embeds 10, it prevents melted wax spillage on top of the cake 40. Once the candles 52 are ready to be removed, grab the holding system with two fingers or more and move the holding system 15 upwardly. The candles 52 and holding system 15 are detached from the cake 40 at the same time, saving removal time and a swifter wax-free slicing/consumption of the cake. Thus, since the preferred material is polyethylene terephthalate (PETE) but not limited to PETE, which is resistant to melting temperatures of candle wax, safe to contact with foodstuffs, the purchaser can reuse product for future celebrations, and/or recycle product participating in environmental-friendliness. FIG. 3a gives a perspective of FIG. 3 placed on top of a cake 40.

### Fourth Embodiment

FIGS. 4 and 4a illustrates another embodiment of the holding system component. This embodiment can be related to the shape of a three level choir stand. FIG. 4 foundation of the holding system 17 comprises of five embeds 10, but not limited to five. The five embeds 10 are horizontally placed next to each other under the base 20 which measures roughly 1 inch width, 3.5 inches in length, and 0.06 inches in thickness. On top of the base 20 extrudes five capture features in horizontal alignment with embeds 10. The base 20 holds embeds 10 and capture features 12 together. The perpendicular base 22 is connected to the estimated 3.5 inch in length side of the base 20 upwardly creating and L shape. There is roughly a 0.125 inch fillet 24 where the base 20 and perpendicular base 22 meet. The process is repeated to make the second and third level of the choir stand-like embodiment. Overall, three bases 20, two perpendicular bases 22, and fifteen holding system components are used with two stability arms 18 under level 2 and 3 of the choir stand-like holding system 17 for added balance embodies the holding system 17.

### Operation

### FIGS. 4 and 4a

The holding system 17 is fairly simple in operation and functionality. The foundational five embeds 10 of the holding system in FIG. 4 are inserted into the cake 42 along with the stability arms 18 for security on top of cake 42. The purchaser can place the fourth embodiment to their liking on top of the cake 42. Once the holding system 17 is positioned on the cake 42, the purchaser can insert fixtures into the capture features 12, preferably birthday candles 52 but not limited to birthday candles. Once implanted, the preferred birthday candles 52 are lit causing an illusion of levitation since the preferred material is polyethylene terephthalate (PETE) but not limited to PETE, which is transparent and resistant to melting temperatures of candle wax, safe to contact with foodstuffs. The purchaser can reuse product for future celebrations, and/or recycle product participating in environmental-friendliness. FIG. 4a gives a perspective of FIG. 4 on top of a cake 42. With the capture features 12 attached to embeds 10, it prevents melted wax spillage on top of the cake 42. Once the candles 52 are ready to be removed, grab the holding system 17 with two fingers or more, move the holding system 17 upwardly. The candles 52 and holding system 17 are detached from the cake 42 at the same time, saving removal time and a swifter wax-free slicing/consumption of the cake 42.

### Fifth, Sixth and Seventh Embodiment

FIGS. 5, 6, 7, and 7a illustrates another embodiment of the holding system component. These embodiments can be related to the shape of a hot wheels track. FIGS. 5, 6, and 7 are circular in dimension and have holding system components connected by bridges 26/28/30 forming a circular wave-like holding system 19/21/23. FIG. 5 is roughly measured with an outer diameter of 5.1 inches and an inner diameter of 4.5 inches, giving the bridge 26 an estimated width of 0.6 inch and height of 0.42 inch. With four wave-like bridges 26 and four holding system components (not limited to four): one holding system component located at the beginning, midpoint, and end of each bridge 26 creates the FIG. 5 embodiment. The preferred material (not limited too) is polyethylene terephthalate (PETE).

FIG. 6 is approximately measured with an outer diameter of 8.9 inches and inner diameter of 8.3 inches, giving the bridge 28 an estimated 0.6 inch in width and height of 0.42 inch. With eight wave-like bridges 28 and eight holding system components (not limited to eight): one holding system component located at the beginning, midpoint, and end of each bridge 28 creates the FIG. 6 embodiment. The preferred material (not limited too) is polyethylene terephthalate (PETE)

FIG. 7 is approximately measured with an outer diameter of 13.1 inches and inner diameter of 12.5 inches giving the bridge 30 an estimated 0.6 inch in width and height of 0.42 inch. With twelve wave-like bridges 30 and twelve holding system components (not limited to twelve): one holding system component located at the beginning, midpoint, and end of each bridge 30 creates FIG. 7 embodiment. The preferred material is polyethylene terephthalate (PETE) but not limited to PETE.

### Operations

### FIGS. 5, 6, 7, and 7a

The purchaser can position FIGS. 5, 6, and 7 on top of or around cakes 44/46/47 as displayed in FIG. 7a. Once the holding system 19/21/23 is positioned on top or around cake 44/46/47, the purchaser can insert fixtures into the capture features 12, preferably birthday candles 52 but not limited too. Once implanted, the preferred birthday candles 52 are lit causing an illusion of levitation since the preferred material (not limited too) is polyethylene terephthalate (PETE), which is resistant to melting temperatures of candle wax, safe to contact with foodstuffs, and clear in tint if preferred. The purchaser can reuse product for future celebrations, and/or recycle product participating in environmental-friendliness. With the capture features 12 attached to embeds 10, it prevents melted wax spillage on top of the cakes 44/46/47. Once the candles 52 are ready to be removed, grab the holding system with two fingers or more and move the holding system upwardly. The candles 52 and holding system 19/21/23 are detached from the cake 44/46/47 at the same time, saving removal time and a swifter wax-free slicing/consumption of the cakes 44/46/47.

### Eighth Embodiment

FIGS. 8 and 8a illustrates another embodiment of the holding system component. This embodiment shape can be related to the ramp skateboarders skate on. FIG. 8 has ten holding system components 10/12 placed along the top of the ramp 32, but not limited to ten holding system components. The diameter of the circular cut out is approximately measured at 4 inches, the height is roughly 3 inches, the top width is estimated at 5 inches with a 0.5 degree taper to increase balance on top of cake 40, and a top thickness of 0.75 inches with a 0.5 degree taper to increase balance on top of cake 40. Since the preferred material (not limited too) is polyethylene terephthalate (PETE) which adds a recycling element aiding the environment by helping with waste management. However, the holding system 25 can consist of any other material. If PETE is chosen, it can be clear in tint assisting in the levitation illusion of the candles 52.

### Operation

### FIGS. 8 and 8a

The purchaser can position FIG. 8 on top of cake 40 as displayed in FIG. 8a, but not limited to what is displayed in FIG. 8a. Once the purchaser decides on the position of holding system 25 on top of cake 40, fixtures can be inserted into capture features 12, preferably but not limited to candles 52. Once implanted, the preferred birthday candles 52 are lit causing an illusion of levitation since the preferred material is polyethylene terephthalate (not limited to PETE), which is clear in tint, resistant to melting temperatures of candle wax, safe to contact with foodstuffs, if preferred. The purchaser can reuse product for future celebrations, and/or recycle product participating in environmental-friendliness. With the capture features 12 attached to embeds 10, it prevents melted wax spillage on top of the cake 40. Once the candles 52 are ready to be removed, grab the holding system 25 with two fingers or more, move the holding system 25 upwardly. The candles 52 and holding system 25 are detached from the cake 40 at the same time, saving removal time and a swifter wax-free slicing/consumption of cake 40.

### FIGS. 9 AND 9a

FIGS. 9 and 9a illustrates another embodiment of the holding system component. This embodiment is a circular tri-level shape holding system 27. FIG. 9 has thirteen holding system components (not limited to thirteen): eight holding systems components on Level 1 34, four holding system components on Level 2 36, and one holding system component on Level 3 38. The measurements of Level 1 34 is approximately 2.95 inches in diameter with a height of 0.60 inch. Level 2 36 is extruded from Level 1 34 roughly measuring a diameter of 1.75 inches with a height of 0.5 inch. Level 3 38 is extruded from Level 2 36 with an approximate diameter of 0.37 inch and height of 0.75 inch. On Level 1 34 and Level 2 36, the holding system components are circularly arrayed at three hundred and sixty degrees. On Level 3 38 the holding system component was placed in the center of Level 3 38. FIG. 9 is also shelled from the bottom roughly measured to 0.04 inch. Since the preferred material is polyethylene terephthalate (not limited to PETE) which adds a recycling component aiding the environment by helping with waste management. However, the holding system component 27 can consist of any other material. If PETE is chosen, it can be clear in hue assisting in the levitation illusion of the candles 52.

### Operation

### FIGS. 9 and 9a

The purchaser can position FIG. 9 on top of cake 48 as pleases. FIG. 9a gives an example of it positioned on top of cake 48 with candles 52. Once the customer places the circular tri-level holding system 27 on top of cake 48, fixtures are inserted into the capture features 12. The fixtures are preferably birthday candles 52. If candles 52 are selected, the candles 52 are lit causing an illusion of levitation since the preferred material is polyethylene terephthalate (not limited to PETE), which is resistant to melting temperatures of candle wax, safe to contact with foodstuffs, and clear in tint if preferred. The purchaser can reuse product for future celebrations, and/or recycle product participating in environmental-friendliness. With the capture features 12 attached to embeds 10, it prevents melted wax spillage on top of the cake 48. Once the candles 52 are ready to be removed, grab the holding system 27 with two fingers or more. Then move the holding system 27 upwardly. The candles 52 and holding system 27 are detached from the cake 48 at the same time, saving removal time and a swifter wax-free slicing/consumption of the cake 48.

### CONCLUSION, RAMIFICATION, SCOPE

While my above descriptions contain much specificity, these should not be construed as limitations on the scope, but rather as an exemplification of several embodiments thereof.

For example, all holding systems can be placed under fondant to change the shape of cakes or all holding systems can be colored to match icing. Also, there could be a holding feature to support the holding systems so all holding systems can be placed above cakes, giving an illusion of floatation. The embodiments can change in size to be larger to enable holding more candles or smaller to handle less. Likewise, the capture features 12 can differ in diameter and depth to capture more or less wax drippings. The materials of the embodiments are not limited to the previously described material (PETE), but if PETE is chosen it will assist in e-friendliness not sacrificing our environmental health for cake aesthetics. The shapes of embodiments are limitless. With vast embodiment shapes, candles can be placed in various forms to increase the options for the purchaser to display an illusion of levitation to their liking.

Accordingly, the scope should be determined not by the embodiments illustrated, but by the appended claims and their legal equivalents.

I claim:

1. A holding system (11,13,15,17,19,21,23,25,27) comprising of numerous components (10,12) and parts (14,16,18,20,22,24,26,28,32,34,36,38) that form a display for inserted features that accompany cakes.

2. A holding system 11 according to claim 1 in which the display is shaped as one of an arc, enabling said inserted features precise placement on top of said cakes.

3. A holding system 13 according to claim 1 in which the display is shaped as one linear formation, permitting even placement of said inserted features on top of said cakes.

4. A holding system 15 according to claim 1 in which the display is shaped as one shooting-star, allowing said inserted features to be placed in a said shooting-star formation on top of said cakes.

5. A holding system 17 according to claim 1 in which the display is shaped as one of a choir stand. Letting said inserted features be presented at different levels from said cakes surface to display a sense of levitation.

6. A holding system 19/21/23 according to claim 1 in which the display shaped as one of a hot wheels track. Allowing said inserted features to be presented at different levels around or on top of said cakes displaying a sense of levitation.

7. A holding system 25 according to claim 1 in which the display shaped as one of a skateboarding ramp. Permitting said inserted features to be presented at different levels on top of said cakes displaying a sense of levitation.

8. A holding system 27 according to claim 1 in which the display shaped as one of a circular multi-level figure. Allowing said inserted features to be presented at different levels on top of said cakes displaying a sense of levitation.
